(19) United States
(12) Patent Application Publication
(10) Pub. No.: US 2004/0117987 A1
(43) Pub. Date: Jun. 24, 2004

(54) Bottle opener for a cabinet

(76) Inventors: Marco Antonio Regnier Pedroso, Joinville-SC (BR); Fabiano Assmann, Joinville-SC (BR); Sthefan Verjas de Almeida, Joinville-SC (BR)

Correspondence Address: DARBY & DARBY P.C., P. O. BOX 5257, NEW YORK, NY, 10150-5257, US

(21) Appl. No.: 10/471,991

(22) PCT Filed: Feb. 8, 2002
(86) PCT No.: PCT/BR02/00025

(30) Foreign Application Priority Data
Mar. 13, 2001 (BR) MU81003730

(51) Int. Cl. B67B 7/00

(52) U.S. Cl. 30/1.5

(57) ABSTRACT

A bottle opener for the cabinet of a refrigerator or other similar storing device, comprising a plate (P) having a fixation portion (10) which is seated and affixed against the cabinet (1), and an opening portion (20) projecting outwardly from the contour of the cabinet (1) and incorporating, inferiorly, a finger (22), which is arranged to engage and retain a small extension of a peripheral edge of a metallic cap (T) crimped to a bottle (G), when the latter has its bottom angularly displaced in the direction of the projection of the opening portion (20) and outwardly from the contour of the cabinet (1).

### FIELD OF THE INVENTION

The present invention refers to a bottle opener to be affixed externally to the cabinet of a refrigerator or other storing device operatively associated to the use of beverage contained in bottles, which are closed by crimped metallic caps.

### PRIOR ART

Crimped metallic caps, which are usually employed to close beverage bottles of various types, require a tool, the so-called opener, for allowing the consumer or the retailer to remove the cap, by deformation of a certain extension of its crimped peripheral edge.

Since the bottle openers usually have small dimensions, it is very common to lose them, particularly in commercial and residential environments, such as hotels, in which the guest has an appliance, such as a mini-bar in his apartment, for helping himself of beverages as desired, without having to call the room service. In hotels, it is very common to have the bottle openers stolen, causing discomfort to the guest in need of this tool, and requiring the hotel administration to make expenses to replace said tool.

Considering the known problem above, the prior art has provided solutions, such as tying the opener to the cabinet, or to any other structure adjacent to the point of consumption or acquisition of the bottle, or incorporating the opener to the cabinet. Some of these solutions are improvised and present drawbacks regarding safety, operation, and even the aesthetic aspect of the arrangement. Other solutions include openers specifically constructed to be affixed to the structure of the cabinet and with a relatively complex construction, requiring a particular fixation to the cabinet, specifically on a vertical front face portion of the latter, which avoids future alteration of positioning, for example, by necessity of reversing the opening direction of the door.

### OBJECT OF THE INVENTION

It is a generic object of the present invention to provide a bottle opener of the type considered herein, presenting a simple and strong construction, and which may be easily incorporated to the structure of a bottle storing cabinet.

It is a specific object of the invention to provide an opener as mentioned above, which may be affixed to the cabinet, without requiring any alteration in the design of the latter, and independently of the direction of rotation of the front door.

### BRIEF DESCRIPTION OF THE DRAWINGS

The invention will be described below, with reference to the appended drawings, in which:

FIG. 1 is a perspective view of the bottle opener of the present invention;

FIG. 2 is a partial schematic upper perspective view of the cabinet of a refrigerator with the door opened and provided with a bottle opener, according to the present invention; and

FIG. 3 is an enlarged vertical sectional view of the upper part of the cabinet of FIG. 2, with the bottle opener being used to remove the metallic cap crimped to the mouth of a bottle.

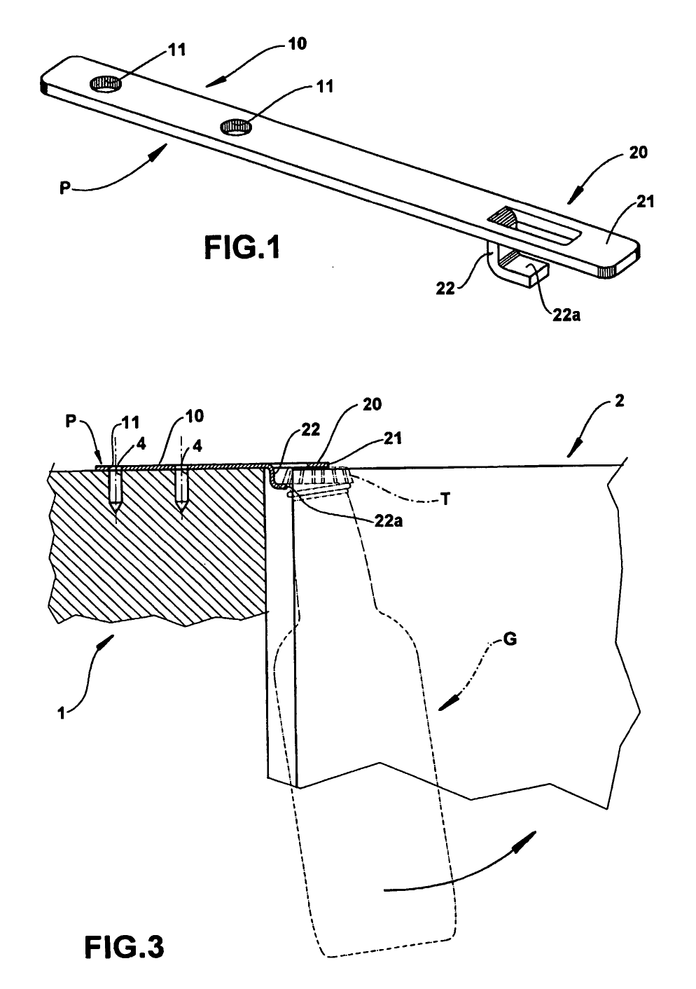

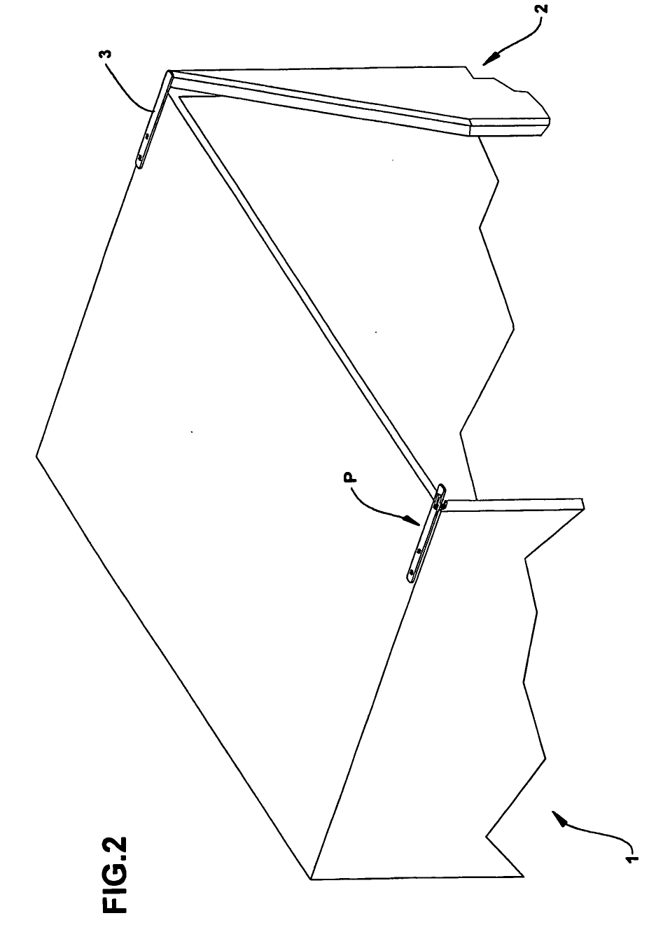

### DESCRIPTION OF THE ILLUSTRATED EMBODIMENT

As illustrated in the drawings and previously mentioned, the bottle opener of the present invention is applied to a cabinet 1 of a refrigerator provided with a front door 2, which is laterally coupled to the cabinet 1, by means of upper and lower hinges, of which only the upper hinge 3 is illustrated.

Cabinet 1 may be defined by other similar storing device constructed to contain beverage bottles closed by crimped metallic caps and which will be opened after being taken out from the cabinet 1.

The cabinet 1 is preferably of the type provided, in the upper wall thereof, with two pairs of anchoring holes 4, which are provided close to the sides of the cabinet, in symmetrical positions in relation to a vertical central plane, one of the two pairs receiving the fixation screws (not illustrated) of the upper hinge 3 of the door 2.

According to the invention, the bottle opener comprises a generally metallic plate P having an elongated rectangular contour with rounded corners, when viewed from above, presenting a fixation portion 10 to be seated and affixed to the cabinet 1, and an opening portion 20 presenting a free end 21 projecting outwardly from the contour of the cabinet 1.

In the illustrated embodiment, the plate P presents the fixation portion 10 and the opening portion 20 mutually coplanar, the fixation portion 10 being provided with at least one throughbore 11 for receiving a respective screw to be attached to an anchoring hole 4, which is previously provided in the upper wall of the cabinet 1, in order to affix the upper hinge 3 upon reversion of the opening direction of the door 2.

However, it should be understood that the fixation portion 10 and the opening portion 20 may be provided in different planes, parallel or not to each other, with the fixation portion 10 being attached to the upper wall of the cabinet 1, or against a lateral or a front wall portion of the latter.

The opening portion 20 incorporates, projecting downwardly and toward the free end 21, a finger 22 with a free edge 22a that is spaced back in relation to said free end 21 of the opening portion 20. In the illustrated example, the finger 22 presents an “L” shaped profile, which is obtained by cutting and bending downwardly a respective extension of the opening portion 20 of the plate P.

As it may be noted, in the preferred constructive form the bottle opener may be incorporated to the top of the cabinet 1, by using the anchoring holes 4 of the latter provided in the side opposite to the articulation of the door 2, not interfering with the movement of said door or with the appearance of the cabinet 1, since the fixation portion 10 works as a finishing for the anchoring holes of the upper hinge on the non-articulated side of the door 2, and the opening portion only slightly projects from the contour of the cabinet 1, on the front face thereof, in order to allow the free edge 22a of the finger 22 to be able to engage and retain a small extension of the peripheral edge of a metallic cap T crimped to a bottle G and which is medianly seated to the lower face of the opening portion 20 during the angular rotation of the bottom of the bottle G in the direction of the projection of the opening portion 20 and outwardly from the contour of the cabinet 1, causing the extraction of the metallic cap.

1. A cabinet of a refrigerator or other similar storing device provided with a bottle opener, said cabinet comprising a front door (2), which is laterally coupled to a cabinet (1) by upper and lower hinges, said bottle (G) being closed by a crimped metallic cap (T), characterized in that it comprises a plate (P) presenting a fixation portion (10), which is seated and attached against the cabinet (1), and an opening portion (20) presenting a free end (21) projecting outwardly from the contour of the cabinet (1), and a lower face, from which projects, downwardly and towards said free end (21), a finger (22) with a free edge (22a) spaced back in relation to the free end (21) of the opening portion (20), in order to engage and retain a small extension of the peripheral edge of the metallic cap (T) crimped to the bottle (G) and which is medianly seated against a lower face of the opening portion (20), during the angular rotation of the bottom of the bottle (G) in the direction of the projection of the opening portion (20) and outwardly from the contour of the cabinet (1).

2. Cabinet, according to claim 1, characterized in that the fixation portion (10) is provided with at least one throughbore (11) to receive a respective screw to be affixed to an anchoring hole (4) provided in the cabinet (1).

3. Cabinet, according to claim 2, characterized in that the anchoring hole (4) is defined by an anchoring hole for the fixation screw of the upper hinge (3) of the door (2), upon reversion of the opening direction of said door (2).

4. Cabinet, according to claim 3, characterized in that the anchoring hole (4) is provided in an upper wall of the cabinet (1).

5. Cabinet, according to claim 4, characterized in that the fixation portion (10) and the opening portion (20) of the plate (P) are mutually coplanar.

6. Cabinet, according to claim 1, characterized in that the plate (P) presents an elongated rectangular contour with rounded corners.

7. Cabinet, according to claim 1, characterized in that the finger (22) is obtained by cutting and bending downwardly a respective extension of the opening portion (20) of the plate (P).

8. Cabinet, according to claim 1, characterized in that the finger (22) presents an approximately “L” shaped profile.
